(19) United States
(12) Patent Application Publication
(10) Pub. No.: US 2006/0231991 A1
(43) Pub. Date: Oct. 19, 2006

(54) Gas spring and method of manufacture

(76) Inventors: Victor L. Chun, Walton Hills, OH (US); Alexander B. Leibman, Strongsville, OH (US); Brian Lee Taylor, Medina, OH (US)

Correspondence Address: SCHNADER HARRISON SEGAL & LEWIS, LLP, 1600 MARKET STREET, SUITE 3600, PHILADELPHIA, PA, 19103, US

(21) Appl. No.: 11/110,352

(22) Filed: Apr. 19, 2005

(51) Int. Cl. F16F 5/00

(52) U.S. Cl. 267/119; 267/64.15

(57) ABSTRACT

A gas spring construction in which a cartridge is fit into each end of a straight sided tube and secured therein with a retaining ring snap fit into an internal groove at each end of said tube. One cartridge has a bore through which a piston rod presses while the other cartridge has a charging valve installed therein. A precharged auxiliary chamber is provided in the piston rod for bore sealed gas springs communicating with the space behind the piston to alleviate the vacuum developing as the piston is stroked to preclude drawing in contaminants. The gas pressure can be set to a level to create a desired spring rate of the gas spring.

### BACKGROUND OF THE INVENTION

This invention concerns so called “gas springs” which have been in wide use in metal working machinery for many years to reliably provide very high spring forces to return components in press operated die sets and in other installations.

Such gas springs include a piston slidable in a sealed housing charged with a gas under high pressure. A piston rod connected to the piston protrudes from one end of the housing, and the housing and piston rod are each connected to relatively movable components to generate a spring force by compression of the gas as the piston moves within the housing.

These devices are typically precharged with nitrogen gas at pressures on the order of 2000 psi with even higher pressures created when fully compressed, and thus are treated as pressure vessels for safety purpose.

For this reason, very high strength alloys are used to construct the housings.

Heretofore, the housings have typically been machined from solid stock, with an integral shoulder or end wall defined at one end of the cylindrical chamber created when the housing is machined. A completely open end is defined at the other end, with a “cartridge” slidably installed therein, with a retaining ring received in an aligned groove in the cylinder wall and a shoulder on the cartridge used to secure the cartridge to resist the pressure in the chamber.

The cartridge is sealed to the cylinder wall with a static seal.

The disadvantage of this approach is the extensive machining required and the waste of costly alloy material. Another difficulty is in providing the great variety of end configurations needed, necessitating a variety of end plates to be affixed to the housing typically by welding.

Other known constructions involve end caps threaded into each end of a straight tube, but a threaded construction requires more extensive machining and threaded connections can work loose from vibrations occurring during service.

Another approach is to weld a closed end cap at one end of a tubular cylinder instead of the integral end wall. Welding requires careful process control to manage dimensional distortion, slowing the manufacturing of the item. This in turn may require carrying an extensive inventory of complete gas springs.

Charging has been accomplished with two different valve installations, a radial machined valve port is provided when a solid, welded or threaded end cap is provided. An axial installation is provided for a cartridge style installation. This varying valve installations creates increased complexity due to the different configurations.

Gas springs are made in “bore sealed” and a “rod sealed” configurations. In the “bore sealed” configuration, a larger diameter piston attached to the rod is sealed to the bore wall with a dynamic seal, and only a scraper seal is provided for the rod.

In the “rod sealed” configuration, the rod is sealed with a dynamic gas seal and the piston is not sealed to the housing wall but rather gas flow past the piston is allowed. This reduces the effective area exposed to the gas pressure to that of the rod cross section, making the spring less stiff.

In this case, the piston merely acts as a stop preventing the rod from escaping from the housing. For this reason, a split piston is often used, freely allowing gas flow past the piston. In other designs, the piston is of smaller diameter than the chamber and is unsealed.

This disadvantage is accepted by designers due to a drawback of bore sealed gas springs involving the development of a partial vacuum between the piston and a shoulder against which the piston is seated in its fully retracted position. This vacuum tends to pull in contaminants past the rod seal and the level of vacuum increases with the stroke of the piston. The presence of contaminants creates increase wear and requires more frequent service of the gas spring.

It is the object of the present invention to provide a lower cost, simplified configuration for gas springs allowing speedier manufacturing without involving extensive machining, welding or threaded connections.

It is a further object of the present invention to provide a bore sealed gas spring which reduces or prevents the tendency for contaminants from entering the housing due to the development of a partial vacuum behind the piston.

### SUMMARY OF THE INVENTION

These objects and other objects which will become apparent upon a reading of the following specification and claims are achieved by a gas spring construction featuring a straight tubular housing closed at both ends by a separate cartridge slidably received therein and secured with a retaining ring. An identical charging valve cartridge is used for both rod and bore sealed springs to substantially simplify the design. This allows premachined tubing and cartridges to be stocked, with only limited finish machining to create a wide variety of gas spring configurations.

This eliminates integral end walls or shoulders to avoid the need to machine the housing from a solid piece, while avoiding any welding or threaded connections.

This configuration is provided in both rod sealed and bore sealed versions.

In the bore sealed version, development of a partial vacuum is avoided by pressurizing an auxiliary chamber in the rod with gas under moderate pressure and connecting the auxiliary chamber to the space behind the piston. The gas in the auxiliary chamber flows into that space as the piston is stroked, preventing the development of a vacuum.

The auxiliary chamber can be pressurized to levels varying with the stroke.

The presence of a pressurized auxiliary chamber communicated to the space behind the piston also can be used to decrease the initial shock to the rod by reducing resistance to movement and also may act as a cushion during the return.

Alternatively, the space behind the should or can be vented and adjacent seals provided on the piston and rod to prevent contaminants from passing by the rod or piston. An identically configured closed end cartridge for both rod and bore sealed gas springs.

### DESCRIPTION OF THE DRAWINGS

FIG. 1 is a lengthwise sectional view of a first rod sealed embodiment of a gas spring according to the present invention in the fully retracted position.

FIG. 2 is a sectional view of the gas spring embodiment shown in FIG. 1 in an advanced condition.

FIG. 3 is an exploded pictorial view of the individual components of the gas spring shown in FIGS. 1 and 2.

FIG. 4 is a lengthwise sectional view of a second bore sealed embodiment of a gas spring according to the present invention.

FIG. 4A, 4B are diagrams showing the relationship between gas pressure and spring rate in the pressurized auxiliary chamber in the embodiment of FIG. 4

FIG. 5 is a sectional view of a second bore sealed embodiment of a gas spring according to the invention.

FIG. 6 is a sectional view of the gas spring shown in FIG. 5 in the fully advanced position.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

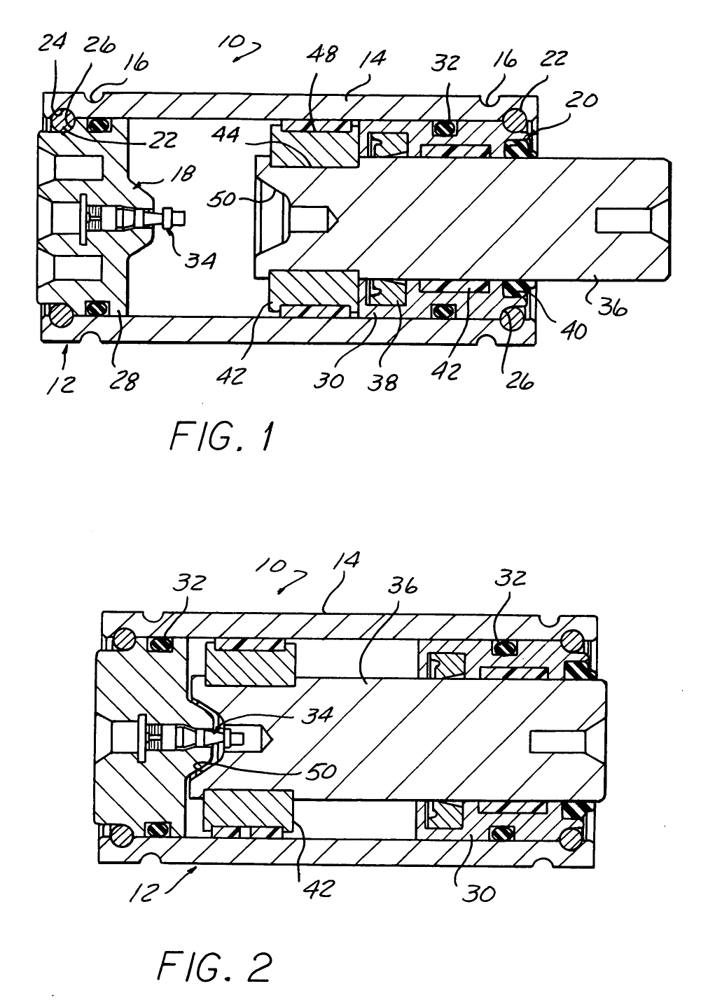

FIG. 1 shows a rod sealed gas spring 10 according to the present invention. The housing 12 is comprised of a length of straight sided tubing 14 with a pair of external grooves 16 machined therein for use in mounting the spring 10.

A pair of cartridges 18, 20 close off a respective end of the tube 14, each retained with a C-ring 22 snap fit into aligned grooves 24 in the inside of the tube 14 and a radiused shoulder 26 in an outside end of a respective cartridge body 28, 30.

An O-ring static seal 32 is received in an external groove in each cartridge body 28, 30.

The closed end cartridge 18 is used to mount a charging valve 34 installed in an axial bore in the body 28. The closed end cartridge 18 is made in identical configurations for both rod and bore sealed gas springs, as described below, to reduce the complexity and cost of manufacture in accordance with the teachings of the present invention.

A piston rod 36 passes through a bore in the opposite cartridge 20, with a seal 38 preventing any escape of gas as the rod 36 is stroked.

A rod wiper 40 is provided to prevent the entrance of any contaminants deposited on the exposed end of the rod 36.

A split band guide ring 42 of a suitable plastic is recessed into an annular recess on the cartridge base acting to minimize wear of the rod 36 as result of the stroking thereof.

A split piston ring 42 is fit into an annular groove 44 in the inside end of the piston rod 36, defining an enlarged piston diameter. A split band piston guide ring 46 is received in an outer recess 48 in the split piston ring 42.

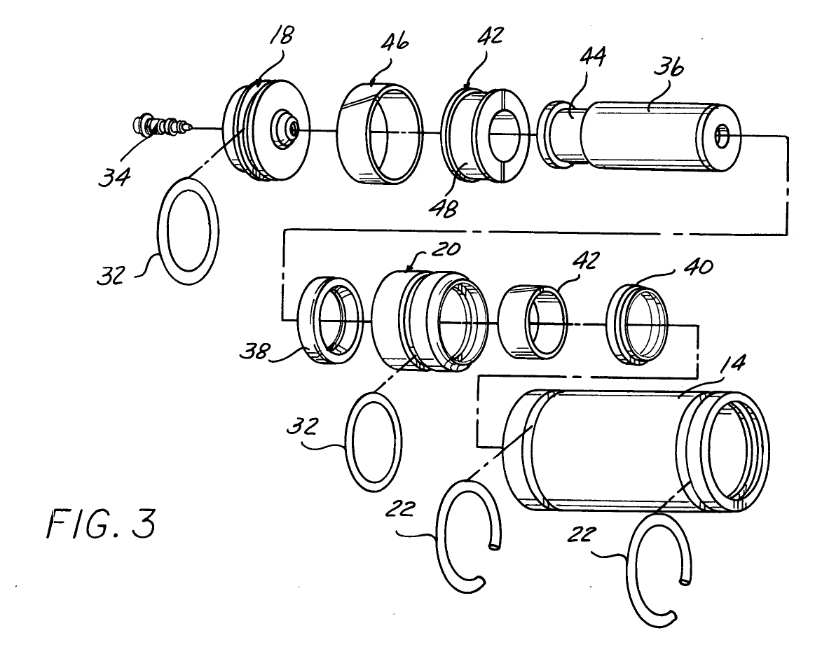

A counterbore 50 is machined into the inside end of the piston rod 36 to accommodate the charging valve 34 as the rod 36 is stroked as seen in FIG. 2.

The split piston ring 42 and split guide ring 46 allow gas to flow past the piston ring 42 as stroking occurs so that sealing is produced only with respect to the rod 36, such that no vacuum is induced in the space 52 behind the piston ring 42.

Since no integral features are required on the tube 14, standard sizes and convenient lengths of premachined tubing can be stocked, and only minor finish machining is necessary to produce a particular size gas spring.

The closed end cartridges can be premachined and stocked for a number of different spring sizes. Various mounting end configurations can also be provided for the closed end cartridges. This is without introducing problems associated with threaded or welded features.

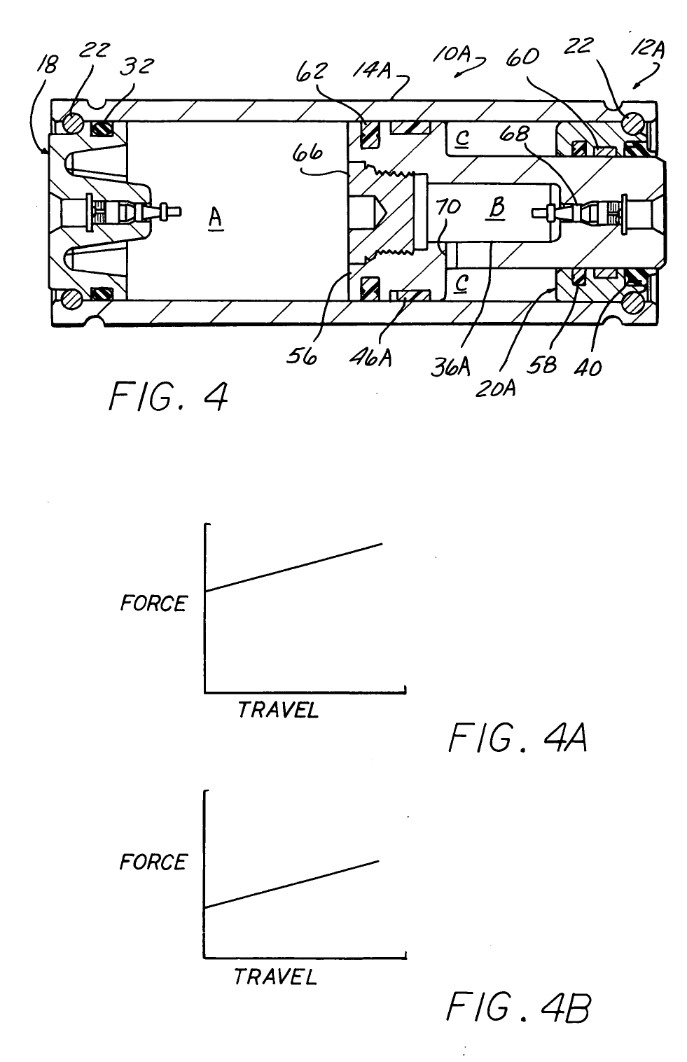

Referring to FIG. 4, a bore sealed configuration of a gas spring 10A according to the invention is shown.

A straight sided tube 14A forms part of a housing 12A, with a pair of cartridges 18 and 20A closing off respective ends of the tube 14A, each retained with C rings 22 snap fit into aligned grooves 24 in the inside of the tube 14A and a radiused shoulder 26 on outer end of a respective cartridge body 28, 30A.

The closed end cartridge 18 is identical with the closed end cartridge 18 of the rod sealed gas spring 10 described above mounting a charging valve 34. An O-ring static seal 32 is used to seal cartridge 18 to the inside of the tube 14A.

A piston rod 36A is made integral with an enlarged diameter piston head 56.

The outside of the rod 36A is engaged with a wiper 40 as well as a seal 58. A smaller sized split band guide ring 60 is also provided.

A bore seal 62 is provided for the piston head 56 so as to prevent gas blow by as the rod 36A is stroked so that the full diameter of the piston head 56 develops spring pressure in chamber A as the piston rod 36 is stroked to the left. A guide ring 46A is provided for the piston head 56.

The piston rod 36A has a stepped diameter bore 64 machined into its inside end, forming a second chamber B, sealed with a threaded plug 66. A second charging valve 68 is provided in the exposed end of the piston rod 36A allowing compressed gas to pressurize the chamber B.

A small radial orifice 70 is machined into the piston rod 36A extending from the chamber B to a chamber C defined behind the piston head 56. This allows a flow of gas from pressurized chamber B to chamber C is a vacuum develops when the piston head 56 is stroked to the left and chamber C increases in volume. This avoids the problem of a vacuum in chamber B drawing in contaminants past the wiper 40 and seal 58 as described above.

The pressure set in the chamber B can be set to a level depending on the length of stroke, i.e., a level to just compensate for the pressure drop as the piston head 56 advances to its full stroke.

The pressure in chamber B (and subsequently chamber C) also affects the spring force, and this can be set higher to tailor the effective spring rate as seen in FIGS. 4A, 4B which show springs without pressure in chamber B and with pressure in chamber B, respectively.

The presence of a gas pressure in chamber B is also a benefit with sufficiently high pressure to reduce the initial shock on the rod 36A and some cushioning in the return stroke.

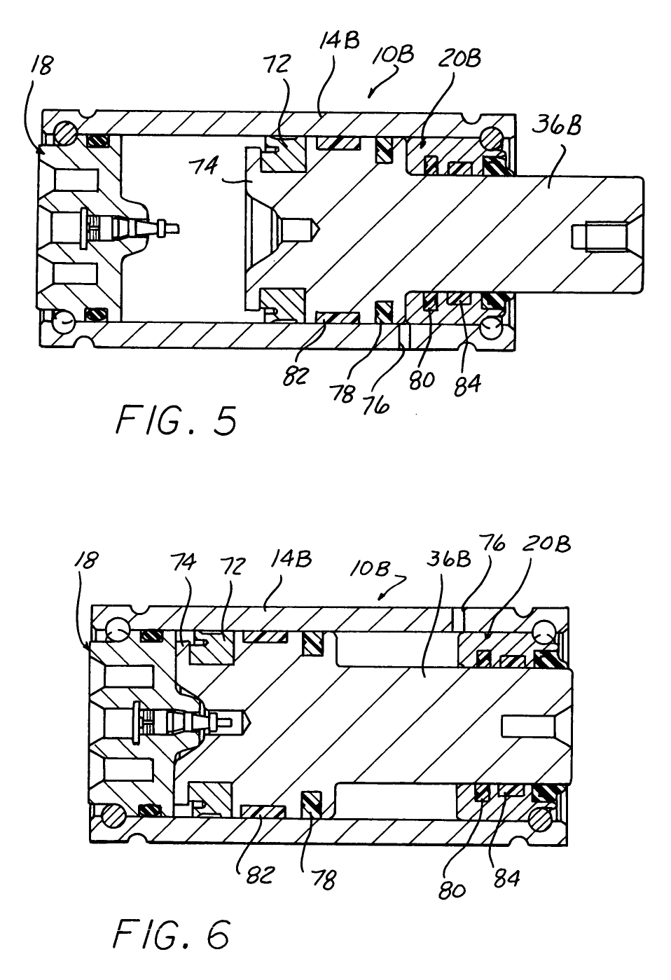

FIG. 5 shows another bore sealed gas spring 10B, with a seal 72 on a piston head 74 integral with the piston rod 36B. In this embodiment, a vent hole 76 is formed through the wall of the tube 14B at the point of abutment of the back of the piston head 74 and the cartridge 20B.

As the rod 36B is stroked, and chamber B forms (FIG. 6), intake of air prevents the development of any vacuum.

Seals 78 and 80 are provided on the piston head 74 and piston rod 36B to prevent any contaminants drawn in with the air from reaching the primary seal 72 or guide rings 82, 84.

It is noted that with sufficiently short stroke gas spring configurations, the pressurized chamber or vented designs will not be required, as the developed vacuum is sufficiently low as to not present a contaminant induction problem.

Thus, a simplified construction allows faster and cheaper manufacture of a wide variety of gas spring configurations.

The advantages of a bore sealed configuration are readily achieved.

1. A gas spring including:
a housing comprising a straight sided tube and a respective cartridge slidably fit into each end of said tube and retained therein with respective retaining rings, each ring received in a respective groove inside each end of said tube;
a piston slidably received in said tube having a piston rod fixed thereto having one end thereof projecting out through a bore in one of said cartridges.

2. The gas spring according to claim 1 wherein the other of said cartridges has a gas charging valve mounted thereto extending axially through said other cartridge into a main chamber defined between facing sides of said piston and said other cartridge.

3. The gas spring according to claim 2 wherein said piston has a seal mounted to the perimeter thereof preventing gas flow past said piston.

4. The gas spring according to claim 2 further including a seal carried by said one cartridge and engaged with said piston rod to prevent escape of gas compressed in said main chamber past said piston rod.

5. The gas spring according to claim 4 wherein said piston comprises two piston ring halves captured on another end of said piston rod to allow gas flow past said piston.

6. The gas spring according to claim 3 wherein said piston rod has an auxiliary sealed chamber formed therein and a charging valve mounted in said one end of said piston rod enabling pressurization of said auxiliary chamber with a gas, said auxiliary chamber placed in communication with a third chamber defined behind said piston and said inside of said one cartridge to allow gas flow from said auxiliary chamber to said third chamber as said piston is stroked towards said other cartridge.

7. The gas spring according to claim 3 further including a vent opening in said tube located to allow inflow of air into a space defined between an inside wall of said one cartridge and a back side of said piston to alleviate a vacuum forming therein as said piston is stroked towards said other cartridge.

8. The gas spring according to claim 7 further including a dirt seal on said piston adjacent said space and a contaminant seal mounted to said one cartridge at a location adjacent said space, said rod contaminant seal surrounding and engaging said rod, said seals preventing contaminants drawn into said space from moving further along said piston and piston rod respectively.

9. A method of manufacturing a series of gas springs of varying configuration including premachining a series of straight sided tubes of various lengths and diameters;
manufacturing a series of pairs of cartridges having body portions slidably fit with respective ends of matching tubes one of each pair of cartridges having a through bore slidably receiving a matching piston rod, and the other of said cartridges having a gas charging valve installed therein;
manufacturing a series of corresponding pistons with piston rods, with pistons slidable in matching tubes and rods slidable in bores in matching cartridges; and
assembling pairs of cartridges into each end of matching tubes, with a matching piston and piston rod, and securing the same with retaining rings each snap fit into a respective internal groove at each end of an associated tube.

10. A method according to claim 11 wherein both rod sealed and bore sealed gas springs are manufactured, and wherein all of said other cartridges are of the same configuration but of varying size.

11. A method for preventing inflow of contaminants into a bore sealed gas spring having a piston and a piston rod slidable in a bore in a housing resulting from development of a vacuum in a space behind said piston as said piston is stroked in said bore comprising pressurizing a chamber in said piston and piston rod assembly with a gas under pressure and communicating said chamber with said space to reduce said vacuum.

12. A method according to claim 11 wherein pressurizing said chamber is done by introducing gas under pressure through a charging valve in an exposed end of said piston rod.

13. A method according to claim 11 wherein said gas is pressurized to a level that will alleviate the vacuum at full stroke of said piston.

14. A method according to claim 11 wherein said as in said chamber is pressurized to a level producing a desired spring rate of said gas spring.

15. A method of alleviating a vacuum developed in a space behind a piston of a gas spring as said piston is stroked by movement of a piston rod in a bore in a housing to compress a gas in a main chamber of said gas spring comprising venting said space to atmosphere.

16. A method according to claim 15 further including sealing said piston and piston rod adjacent said space to prevent passage of contaminants drawn into said space.
